(19) United States
(12) Patent Application Publication
(10) Pub. No.: US 2025/0323916 A1
(43) Pub. Date: Oct. 16, 2025

(54) SECURE EXPOSURE OF ACCESS POLICIES FOR PROTECTED RESOURCES

(71) Applicant: SAP SE, Walldorf (DE)

(72) Inventors: Tobias Dyrba, Edingen-Neckarhausen (DE); Steffen Koenig, Heidelberg (DE)

(21) Appl. No.: 18/631,653

(22) Filed: Apr. 10, 2024

(51) Int. Cl. H04L 9/40

(52) U.S. Cl. CPC H04L 63/10

(57) ABSTRACT

The present disclosure relates to computer-implemented methods, software, and systems for managing access to protected resource and aim at mitigating the risk of denial of services for the resources. A first request is received by an access policy manager from an automation tool to obtain access policy metadata of a first resource provided at a first data storage. A second request is sent to access an interface at the first data storage to obtain the access policy metadata. The second request is generated according to a type of the first data storage. The access policy metadata relevant for the first resource is obtained to provide the access policy metadata to the automation tool.

### TECHNICAL FIELD

The present disclosure relates to computer-implemented methods, software, and systems for secure data processing.

### BACKGROUND

Software applications can provide services and access resources. Resources may be restricted to a limited number of users based on user rights and roles. Tokens, credentials, keys, or other suitable methods and tools can be used to authenticate requests to gain access to restricted resources. When a user requests access to a resource, the user may be validated to determine whether the user is authorized to access the resource.

### SUMMARY

The present disclosure involves systems, software, and computer implemented methods for managing access to protected resource and aim at mitigating the risk of denial of services for the resources due to fault access attempts with incorrect credentials that can lead to locking of a resource(s).

One example method may include operations such as: receiving, by an access policy manager and from an automation tool, a first request to obtain access policy metadata of a first resource, wherein the first resource is provided at a first data storage; in response to the first request, sending, by the access policy manager, a second request to access an interface at the first data storage to obtain the access policy metadata, wherein the second request is generated according to a type of the first data storage; and obtaining the access policy metadata relevant for the first resource to provide the access policy metadata to the automation tool.

In some implementations, sending the second request comprises: identifying the type of the first data storage; and generating the second request according to a metadata schema associated with the type of the first data storage to obtain the access policy metadata. In some implementations, the method can include instantiating one or more validator components. Each validator component can be associated with a type of a data storage and can be configured to generate requests according to a respective metadata schema associated with the respective type of the data storage. In some instances, sending the second request can include identifying a validator component corresponding to an identified type of the first data storage. The second request is generated at the validator component.

In some implementations, the automation tool is configured to execute resource management operations over resources comprising the first resource. The executed resource management operations can be pre-evaluated based on processing obtained access policy metadata from the access policy manager. The obtained access policy metadata can include a threshold lock policy value for the first resource.

In some instances, the method can include: obtaining, by the automation tool, the access policy metadata relevant for the first resource; and determining, by the automation tool, whether to validate new credentials provided for accessing the first resource at the automation tool by using a threshold lock policy value for the first resource as obtained from the access policy metadata for the first resource. In some instances, the automation tool can be configured to send the first request to the access policy manager responsive to a received request from an entity to change account credentials to be used when authenticating the entity for accessing the first resource at the first data storage. In some instances, the second request can be sent by the access policy manager to the first data storage to be authenticated at the first data storage based on credentials provided by the access policy manager. The credentials can be obtained through the first request received from the automation tool. The credentials can be validated to determine whether the second request is associated with an entity authorized to access resources at the first data storage. In some instances, the access policy manager can be communicatively coupled to a plurality of data storages, where at least two data storages can be of different type and associated with a different metadata schema.

In some instances, one or more threshold lock policy value for one or more respective resource can be obtained by the automation tool based on the provided access policy metadata by extracting a respective threshold lock policy value from the respective access policy metadata. In some instances, the automation tool can receive a third request to change an old log-in credential of an account for authenticating to access a resource to a new log-in credential. The third request can be received from an entity authenticated at the automation tool. The automation tool can be configured to execute resource management operations over resources comprising the resource. The automation tool can determine whether to validate the new log-in credential by determining whether a tracked number of attempts to access the resource by the account has reached a threshold lock policy value for the resource. The threshold lock policy value can be identified as relevant for the resource as being associated with the third request to change the old log-in credential to a new log-in credential for the account. In response to invalidating the new log-in credential by determining that the tracked number of attempts to access the resource exceeds the threshold lock policy value, changing the old log-in credential to the new log-in credential can be denied by the automation tool.

Similar operations and processes may be performed in a system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description, the drawings, and the claims.

### DESCRIPTION OF DRAWINGS

FIG. 1 illustrates an example computer system architecture for managing authorization of requests to access resources that are protected according to a relevant access policy in accordance with the implementations of the present disclosure.

FIG. 2A is a flowchart for an example of a method for mitigating risks of locking an account for managing resources based on obtaining an access policy applied at a data storage providing the resources in accordance with implementations of the present disclosure.

FIG. 2B is a block diagram for an example of a system environment for obtaining access policies metadata for a protected resource in accordance with implementations of the present disclosure.

FIG. 3A is a flowchart for an example of a method for obtaining access policies metadata for a protected resource in accordance with implementations of the present disclosure.

FIG. 3B is a flowchart for an example method for processing requests for updating credentials for accessing a resource in accordance with implementations of the present disclosure.

FIG. 4 is a block diagram for an example of a system environment for dynamic retrieval of access policies of various resources provided by multiple data storages in accordance with implementations of the present disclosure.

FIG. 5 is a schematic illustration of example computer systems that can be used to execute implementations of the present disclosure.

### DETAILED DESCRIPTION

The present disclosure describes various tools and techniques for managing access to protected resources and mitigating the risk of denial of services for the resources due to faulty access attempts with incorrect, invalid, or unauthorized credentials that can lead to the locking of a resource(s). In some instances, the present disclosure describes techniques for obtaining relevant access policies applied to protected resources to support authorization requests to access resources by parties providing access credentials.

In some instances, an application can communicate with resource providers such as servers, data storages, and/or data centers, and request operations related to resources (e.g., access resources, manage access credentials to resources, other). The communication between the application and the resource provider can be a secure communication where the application authenticates at the resource provider, for example, by providing credentials (e.g., username and password, identity data, etc.) of the requestor (e.g., a user or a client application, among others). The provided credentials can be validated at the resource provider according to an access policy applied at the resource provider for the particular resource being requested. For example, if multiple attempts are made to access a resource with false credentials, the resource provider may lock the resource for a period of time. In that example, a threshold number of attempts may be defined as part of the access policy used to determine when to lock the resource (i.e., locking occurs after 3 failed accesses).

In some instances, an automation tool can be configured to act as an intermediary between an application and a resource provider. In some instances, the automation tool can be delegated actions to manage resources that are used by the application. For example, the application can provide services to end-users or customer-entities based on accessing resources from a data center, and the application can delegate, to the automation tool, the management of these resources. In some instances, management of resources can include operations that are related to the lifecycle of the resources. For example, management of resources can include lifecycle operations including data replication, backup, update and/or upgrade operations, or data cleaning (e.g., removing files based on a criterion, e.g., outdated), among other example operations that can be delegated.

In some instances, the automation tool can be configured with access rights to execute delegated actions to manage resources. The automation tool can receive instructions for performing the actions and/or information about accessing the resources from a requestor. The requestor is associated with the application delegating the actions can be, for example, a user, the application, or a service, among other examples. In some instances, the automation tool can be configured with defined flows based on requests for managing resources. In some cases, the configured flows can be procedures including actions that are to be executed on a schedule (e.g., every day, every month, upon receipt of a notification, event-based, or based on subscriptions, among other examples of time, cause, or other types of schedules or triggers).

In some instances, the automation tool can be set up with a plurality of accounts (e.g., relevant for different configured flows for execution), where different accounts can be relevant for different entities. In some instances, a set of resources can be accessible from a single account and can use the same credentials. In some instances, the automation tool can be provided with credentials for executing actions to and/or with the resources. For example, the credentials can be provided for the action execution by a privileged user defined at the automation tool and associated with the requesting application.

In some instances, the automation tool can obtain access policy information about resources to be used in cases where validation of account credentials associated with the application (e.g., at one or more data storages or data centers) is performed, for example, when account credentials are used for accessing the resources. In some instances, by obtaining the access policy information, the automation tool can validate requests to access resources received from applications and the account credential without locking an account (and limiting the access to resources from that account) and/or without revealing sensitive information about the requesting entity. The validation performed at the automation tool can be based on monitoring of requests sent for the resource as well as applicable access policy, thus reducing the chance that a malicious party would be able to mount attacks if credential information (that is sensitive information) is leaked.

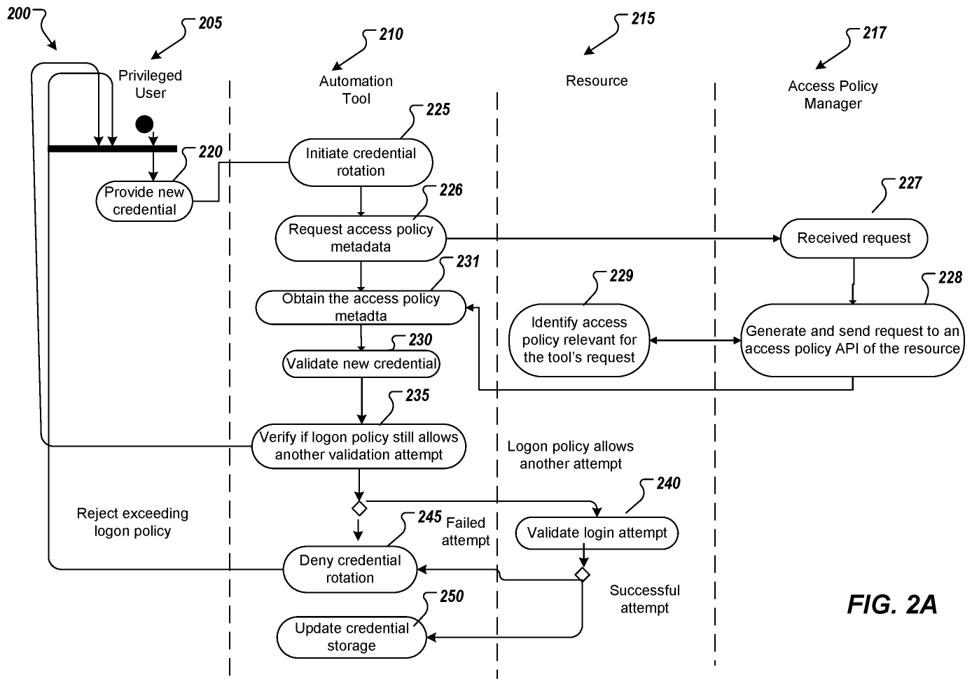

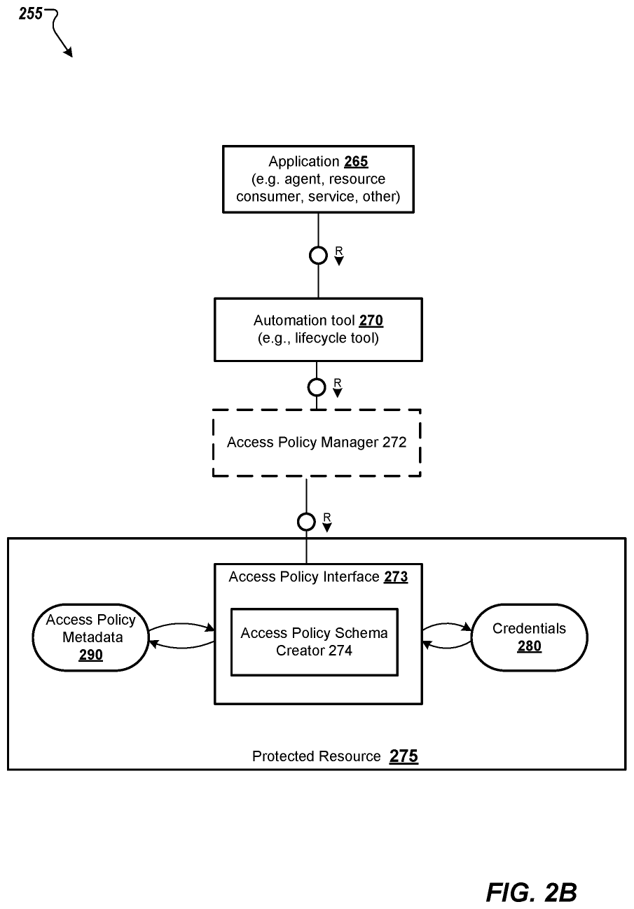

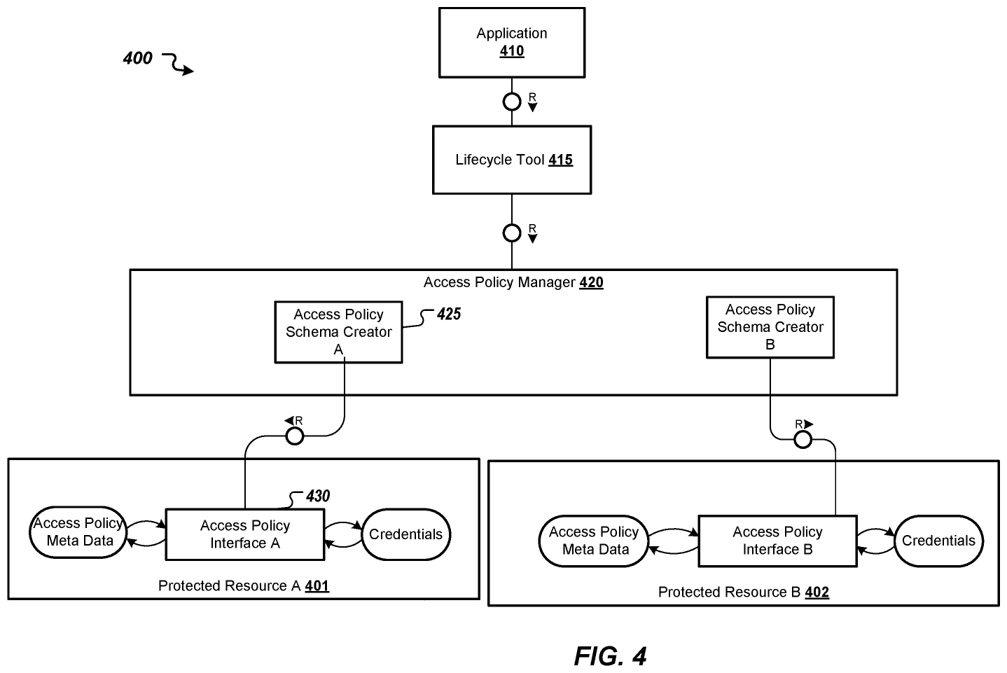

In some implementations, the automation tool can be configured to use an access policy manager (e.g., as a component part of the automation tool, as an external component as shown on FIG. 4, or as part of the resource as shown on FIG. 2B) that can interface with resource providers and obtain access policies for resources to manage protected resources in a secure yet efficient manner. In particular, the solution provides significant advantages in environments with high throughput. In some instances, an automation tool can be configured to manage resources for an application (or other resource consumer or technical agent) and thus obtain access policy metadata (e.g., including log-on metadata) for the managed resources. The access policy metadata can be metadata provided from the managed resources (e.g., a database storing data, a file storage, etc.). The access policy metadata can be utilized by the resources at their data storages (e.g., data centers, cloud and/or on-premises platforms, or other resource providers) when requests are received for resources directly and not through the automation tool.

In some instances, credentials required for authentication to execute an action on or with a resource (e.g., an action to manage the resource) may be rotated or updated within a resource. In some instances, the rotation of the credentials can be performed to improve the protection of the resources and to lower the risk of fraudulent requests to the resources if a credential is leaked. In some instances, the resource can be defined with a log-on policy including rules for locking out accounts that attempt to access the resource multiple times with invalid credentials. For example, if an entity attempts to use more than a few unsuccessful passwords while trying to log on to a system providing the resource, this might be a malicious entity that is attempting to determine an account password by trial and error. In some instances, if multiple unsuccessful attempts are made, the account used for accessing may be disabled for a preset period of time. In some instances, a log-on policy can define a threshold for disabling the access to the resource and/or actions that can be taken after the threshold is reached.

In those cases, the automation tool can be provided with updates to the current valid credentials for authentication. For example, those updates can be received when the credentials for the resource are changed. Thus, after a credential rotation is executed for the resource, the automation tool can be updated with the new credentials so that the tool can continue accessing the resources by validly authenticating with the new credentials. In some instances, the update for the new credentials at the automation tool can be performed by a privileged user defined at the tool and associated with the resource and also, optionally, with the application or service associated with actions of the automation tool to manage the resource. In some instances, rather than a privileged user, the update of the credentials can be performed through other entities or tools for providing the new credentials, including through an application or service, or through a push notification from a server hosting the resource, among other example options. In some instances, the credentials that are used for authentication can be include different tokens or data that can be used to authenticate towards the resource, such as username and password, tokens, biometric credentials, keys, or other types of credentials.

In some instances, an entity that can be validly authenticated at the tool (e.g., a user or an application that is authenticated with a name and a password, tokens, or keys at the tool) can request to change the credentials used for authentication towards managed resources at the tool to invalid credentials. In some cases, such an entity can purposefully provide the invalid credentials in an attempt to lock the tool's access to the resource, since the tool would use the credentials several times and too many failed authentication requests can activate the locking of the resource (e.g., based on the log-on policy of the resource). In some other cases, the entity can provide the invalid credentials unknowingly. However, this can still result in the locking of the account used to access the resource with the invalid credentials. The locking of the account can affect the access to the particular resource as well as to other resources whose access is based on the same account.

In some instances, if an automation tool is provided with a new credential that is not a valid one, the tool may attempt to execute functionality related to the resource and authenticate with the invalid credentials. If the authentication fails multiple times, this can lead to the resource being locked from the tool. If the access policy for the resource is unknown to the automation tool, the automation tool may not be aware of a limit (e.g., a retry quota) to the number of attempts to authenticate with the provided credentials before risking the account being locked. If the account becomes locked, even if the automatic tool obtains new credentials that are valid, the account may be unusable for a period of time corresponding to the log-on policy of the resource. In some cases, that can lead to failed service execution by the automation tool, since during the locked period no actions from the tool can be performed based on the locked account. This can affect the performance of the tool when executing other actions for other resources relying on the same account.

In accordance with implementations of the present disclosure, the automation tool can be configured with logic to process requests for changing credentials by internally validating the requests based on stored information for access policies for resources. In some implementations, the automation tool can be configured to obtain the information related to the access policies for the resources and store that information, so that the automation tool applies the relevant (current and/or up-to-date) policies when validating requests to reduce the risk of locking an account. In some implementations, obtaining the access policy metadata can be performed through an access policy manager that can be instantiated at the automation tool or as an external component in communication with the automation tool and the protected resource(s).

For example, the automation tool may obtain and store information about the log-on policies for resource A by using the access policy manager operable to invoke an interface at the provided resource, where that invoked interface can provide relevant and up-to-date access policy metadata. In some instances, the access policy manager can be configured to invoke different interfaces of different resource providers, where the different providers may be associated with multiple different technologies and/or of different types. In some instances, the type of a resource provider (e.g., a database) may be relevant for determining and generating a request from the access policy manager to the resource provider to obtain the access policy metadata.

In some instances, the automation tool can be configured to communicate with one or more applications and provide data management services for resources stored at one or more resource providers. The access policy manager can implement logic to process requests from an automation tool and obtain relevant access policy metadata for resources associated with the automation tool to support the automation tool in validating operations requested at the automation tool.

In some instances, the automation tool can process requests from various applications without modifications at the application or at the automation tool itself. In some instances, the access policy manager can be external to and separate from the automation tool and provide the access policy metadata to the automation tool so that the access policy metadata is stored and used by the automation tool. In some instances, the access policy manager can be installed on and run as part of the automation tool to obtain relevant access policy metadata from resource providers. The access policy manager can be configured to process requests from one or more automation tools and to generate requests to obtain access policy metadata based on internal logic. In some implementations, the access policy manager can generate different requests to obtain access policy metadata for different types of resource providers, as these different types of resource providers may have different protocols for communicating and structuring the storage of data.

In some implementations, the automation tool can act as a proxy between an application and a resource provider in such a way that when a request associated with a resource is received, the automation tool can determine whether and/or when to access the resource. This determination can reduce the risk of locking the account of the requesting application and preventing it from accessing resources. For example, the automation tool can store access policy information which can include information defining that upon three unsuccessful attempts to authenticate requests of the tool using the same account, the access to the resource would be locked. In those instances, when the automation tool is provided with new credentials, the automation tool may check a number of times the new credentials have been used without successful authentication, and then can compare that amount with a number of allowed attempts that would not lead to locking the resource even if the credentials are wrong (e.g., in this case two (2)). This check can be performed at the automation tool without actually performing an authentication at the resource that could lead to potential locking. The validation can be performed based on using access policy metadata that can be dynamically obtained from the resource provider through the access policy manager in accordance with implementations of the present disclosure. In some instances, the number of unsuccessful authentication requests within a predetermined period of time can be tracked (e.g., as defined in the log-on policy), so that a time gap between any two of the requests would not exceed a determined period of time after which the counter for tracking the number of requests for authentication would reset. Such a time gap can be defined in the log-on policy and can be used by the resource when authenticating requests, and such behavior can be mimicked at the tool. In some instances, the tracking of attempts and managing of requests for accessing resources and/or changing credentials for resources can be performed as described in U.S. application Ser. No. 18/519,236, filed on Nov. 27, 2023 under Attorney Docket No. 22135-1781001, and titled “MITIGATION OF RISK OF DENIAL OF SERVICES FOR PROTECTED RESOURCES”, which is hereby incorporated by reference in its entirety.

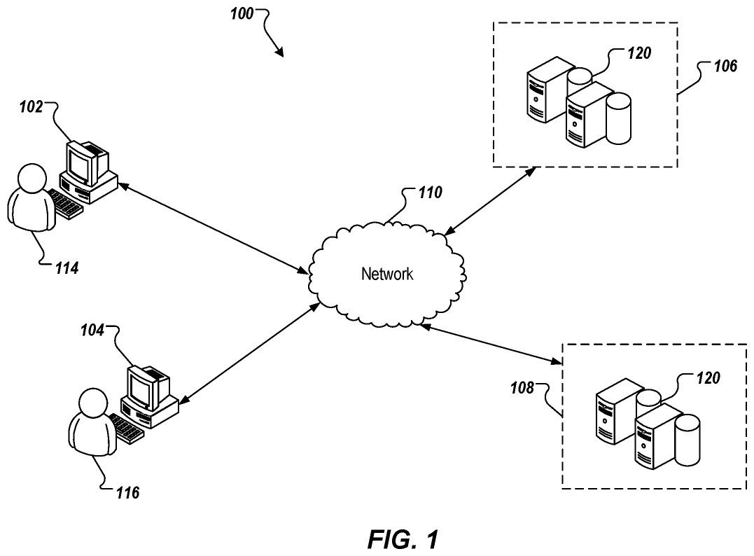

FIG. 1 depicts an example architecture 100 in accordance with implementations of the present disclosure. In the depicted example, the example architecture 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications, application servers, and authorization servers to support execution of secure requests between the client applications and the application server. In some instances, the user 114 or 116 may access a client application through the network 110. The client application may be communicatively coupled with an application server. The application server may include application logic implemented to provide services and resources to end users.

In some instances, the environments 106 and 108 may host an automation tool as previously discussed that is configured to execute actions (e.g., as part of implemented functionality of the automation tool). The automation tool can be set up to automate processes to be executed at a resource, where the resource may be provided by another entity such as a data center, application server, storage, service, application, or other. In some instances, the automation tool can be provided with access credentials to access a resource and execute an action based on the credentials. In some instances, the credentials provided to the tool for accessing one resource may also be valid for accessing another resource, for example, access based on the same account with the same credentials. Each of the resources may have a log-on policy to process requests for authentication and to determine when to lock access to the resource in case of unsuccessful authentication with invalid credentials. In some cases, some or all of the resources can be associated with the same log-on policy, or there can be a specific configuration of the log-on policy defined for each resource.

In some instances, the environments 106 and 108 may also host an access policy manager as a separate component or as part of the automation tool. The access policy manager can be configured to obtain access policy metadata from resource providers and provide the access policy metadata to the automation tool to be stored and used for validating requests related to resources. The access policy manager can be configured to work with one or multiple automation tools and/or applications that can use access policy metadata to configure their process flows to manage requests to resources. In some instances, the access policy manager can provide different policy validators that can obtain access policies from different types of resource providers that have specific communication requirements and may involve different syntax for generating the requests.

FIG. 2A is a flowchart for an example method 200 for mitigating the risk of locking an account for managing resources based on a fraudulent credential in accordance with implementations of the present disclosure. In some instances, the method 200 can be executed in the context of the execution of a request by the automation tool 210 for a resource 215 as part of a configured process for managing the resource 215 as described throughout the application and with illustrated examples at FIGS. 1, 2B, 3A, 3B, and 4.

In some instances, the resource 215 can be stored at a resource provider (e.g., a data center, database, etc.) together with other resources that can be managed by the automation tool 210. For example, the management of resources can include at least one of resource updates, resource upgrades, resource replication, or resource deletion, among other examples.

In some instances, the automation tool 210 can be configured to execute preconfigured flows related to managing the resource 215. In some implementations, the preconfigured flow(s) can be defined for automatic execution of a series of actions. In some instances, the preconfigured flow(s) can be defined based on requests received from an application, a service, or another entity. In some instances, one account may be valid for some or all resources, or one account may be valid for a particular flow type, where multiple accounts may have access to execute operations related to the resource 215.

In some implementations, the automation tool 210 can be configured based on received requests from external entities, including users, applications, services, or other software components. In some instances, to perform such automation tasks, the automation tool 210 can be provided with credentials that would allow access to the resources that the automation tool 210 is configured to manage. In some instances, an entity such as an application, can delegate operations to be executed by the automation tool 210. In some instances, actions defined in flows can be performed to manage resources and may be repetitive tasks that have to be executed according to an execution scheme defining periodicity or triggers for initiation of the flow's executions. For example, resources associated with an application may be backed-up according to a backup scheme defining a time schedule for execution of back-up operations, and such back-up processes can be executed by the automation tool 210 instead of the application.

In some instances, the automation tool 210 can be configured with an account(s) associated with the preconfigured flow(s). One or more accounts can be configured at the automation tool 210, and can be provided with credentials for authenticating to execute operations at resources, which can include the resource 215. In some instances, the automation tool 210 can be configured to execute a request to perform an operation (e.g., as a single operation or as part of a configured flow) related to the resource 215. The execution of the operation can be related to a configured task associated with an entity, such as an application or user. For example, the execution may be based on a scheduled job for execution of an action defined at a preconfigured flow. In some instances, the automation tool 210 can connect with the resource 215 based on credentials that are stored in the automation tool 210 for the resource. The automation tool 210 provides the credentials to authenticate for accessing the resource 215. The resource 215 validates the attempt of the automation tool 210 based on the provided credentials.

At 220, a privileged user 205 authenticated at the automation tool 210, sends a request to initiate, at 225, a credential rotation, by providing a new credential to the automation tool 210. In some instances, a privileged user 205 can be user of an application that is configured to use the automation tool 210 and is authorized to send requests for actions (e.g., such as change credentials, request modifications to settings, change configured flows at the automation flow, other) to be performed by the automation tool 210. The new credential is to be used when the automation tool 210 sends requests to perform operations with the resource 215 that require authentication.

At 226, the automation tool 210 sends a request to obtain access policy metadata from an access policy manager 217. The access policy manager 217 can be configured as a secure component that can run as a standalone component or as part of the automation tool 210. The access policy manager 217 can process the received request at 227 and generate and send, at 228, a request to the resource 215 to obtain access policy metadata for the resource 215. In some instances, the access policy manager 217 can send the request to an interface (e.g., an application programing interface (API)) provided by the resource 215 to obtain the access policy metadata. The resource 215 can receive the request and identify, at 229, the access policy metadata relevant for the request and provide it to the access policy manager 217. The access policy manager 217 can provide the obtained access policy metadata from the resource 215 to the automation tool 210. The automation tool 210 can obtain the metadata, at 231, and also store the obtained access policy metadata as part of the obtaining operation 231.

In some instances, the access policy manager 217 can obtain access policy metadata for the resource 215, where the access policy metadata can include information for the log-on policy for the resource 215, as well as other related information. The other related information can include information for a time gap between requests for authentication that, if exceeded, can cause a subsequent request(s) to be considered separately and/or as unrelated to previous requests, so that the counter for tracked unsuccessful requests would be restarted. For example, a number of tracked attempts to access a resource can be four (4) (e.g., tracked based on requests executed through the tool 210) and the log-on policy can define a threshold number of attempts to be five (5). In this example, the automation tool 210 may allow the execution of a subsequent request to access the resource after expiry of the specified time gap between the requests, as obtained from the information related to the log-on policy of the resource. In some instances, the automation tool 210 can hold on sending the request until the expiry of the specified time gap. In some instances, the automation tool 210 can decline the request and await a subsequent request that can be processed and approved as performed according to the implemented validation logic at the automation tool.

In some instances, the automation tool 210 can identify the access policy metadata as stored at the automation tool 210, instead of requesting it at 226. In those instances, the metadata can be provided, as described in relation to operations 226, 227, 228, and 229 prior to receiving the initiation request 225. In some instances, the automation tool 210 can be used in connection with various resources, and the automation tool 210 can be configured to obtain access policy metadata for the relevant resources through the access policy manager 217. In some instances, the access policy metadata can be obtained and pre-stored at the automation tool 210 to be used for subsequent requested operations or can be obtained dynamically as part of processing a request to perform operations in relation to a resource. In some instances, the dynamic obtaining of the access policy metadata can be configured so that up-to-date and current policy data can be obtained, where such policy metadata can be obtained from the resource 215 in real-time in response to requests, and may not be pre-stored. In some instances, the policy metadata can be cached for a period of time after the metadata is dynamically obtained. In such cases, the processing of validation of credentials at the automation tool 210 can be efficiently and flexibly configured to rely on current access policies that can be dynamically modified for the resource and policy modifications can be easily distributed and shared with the automation tool 210.

At 230, the received new credential is validated at the tool. At 235, the obtained access policy metadata can be used to determine a log-on policy that is configured for the resource. The new credential can be verified to determine if the log-on policy allows execution of a validation based on the new credentials. If the new credential is not a valid credential for the resource, an attempt to access the resource would result in locking the access to the resource 215. If it is determined that the log-on policy does not allow the performance of one more attempt without risking potential locking of the resource 215, the request to rotate the credentials is denied and the denial is provided to the automation tool 210 and as a notification to the privileged user 205.

If the log-on policy allows another validation attempt of the credentials as determined at 235, the automation tool 210 can provide, at 240, the credentials to request access to the resource 215. In such a way, the resource 215 validates the log-in attempt with the new credentials. If the validation at 240 fails, at 245, the resource 215 provides a denial of rotation notification to the automation tool 210. The automation tool 210 can transfer the notification for the denial to the privileged user 205. If the validation at 240 is successful, at 250, the credentials are updated at the automation tool 210. The credentials can be updated by the automation tool 210 by storing the credentials as the current valid credentials at a storage.

In some instances, the automation tool 210 can set up a counter to track a number of unsuccessful requests that are performed for the request as part of the verification at 235. If the automation tool 210 is aware of the log-on policy of the resource 215, the automation tool 210 can compare the counter number with the policy to determine whether to allow subsequent requests to access a resource. The comparison with the counter number can be performed in an attempt to minimize the risk of locking the access to the resource if the number of unsuccessful requests reaches the log-on policy threshold value for allowed unsuccessful tries before locking the access.

FIG. 2B is a block diagram for an example of a system environment 255 for obtaining access policy metadata for a protected resource in accordance with implementations of the present disclosure. In some instances, the system environment 255 includes an application 265 that can be an agent, resource consumer, service, or other entity that is running and performs operations that require access to resources, for example, the protected resource 275. In some instances, an automation tool 270 can be configured to execute preconfigured flows related to managing resources accessible by the application 265. In some instances, the automation tool 270 can be substantially similar to the automation tool 210 of FIG. 2A and can be configured to perform actions as described in relation to FIG. 2A.

In some instances, the automation tool 270 may be configured to access the protected resource 275 for execution of operations related to the application 265. In some implementations, the automation tool 270 can include data for preconfigured flow(s) that can be defined for automatic execution of a series of actions. In some instances, the preconfigured flow(s) can be triggered based on requests received from the application 265, or based on rules defined for initiating process flows for the application 265, among other examples. In some implementations, the automation tool 270 can be a lifecycle tool that can be configured to perform operations in relation to multiple applications (including the application 265) and perform lifecycle operations related to resources at various data sources (including the protected resource 275).

In some instances, the automation tool 270 can be configured based on received requests from external entities, including users, applications, services, or other software components, to provide services related to protected resources. In some instances, the automation tool 270 can be provided with credentials that when used can allow access to resources which the automation tool 270 is configured to manage. In some instances, actions defined in flows as described in relation to FIG. 2A can be performed to manage resources and may be configured for execution at the automation tool 270.

In some instances, the automation tool 270 can be configured with an account(s) associated with the application 265, where the account can be used for authentication of actions associated with preconfigured flow(s) or operations in relation to accessing resources such as the protected resource 275. One or more accounts can be configured at the automation tool 270 that can be associated with one application, such as the application 265, or with multiple applications. One account may be used for authenticating at one or multiple resource providers. The automation tool 270 can provide the credentials to authenticate for accessing the protected resource 275, where a determination whether to request the accessing operation can be performed by validating the request according to stored information at the automation tool 270 for access policies related to the accessed resources.

In some instances, the automation tool 270 can be communicatively coupled to an access policy interface 273. The access policy interface 273 can be requested directly by the automation tool 270, or can be requested through an external component, such as the access policy manager 272, running separately from the protected resource 275, and supporting the communication between the automation tool 270 and the protected resource 275. In some instances, the access policy interface 273 can be queried by the automation tool 270 to obtain access policy metadata for the protected resource 275. The access policy interface 273 can be implemented to process a received request from the automation tool 270 or from the access policy manager 272 and generate a response including relevant access policy metadata 290 as stored at the protected resource 275. In some instances, when the automation tool 270 uses the access policy manager 272, the automation tool 270 may be unaware of the specifics of requesting metadata from the protected resource and may not be configured with logic to invoke the access policy interface 273. In some instances, the automation tool 270 can send requests for access policy metadata to the access policy manager 272 that can include a metadata creator that is configured to communicate with the specific access policy interface 273 (and comply with the specific format and parameters relevant for obtaining the access policy metadata). In some implementations, the access policy metadata 290 may be stored in a format that is specific to the type of the resource. In some instances, the access policy interface 273 includes an access policy schema creator 274 that can obtain data from the access policy metadata 290 as stored at the protected resource 275 and provide it as relevant access policy metadata to the automation tool 270 in a format that is compatible with the automation tool 270.

In some instances, the access policy schema creator 274 can obtain the access policy metadata 290 for the protected resource 275 by sending a request according to a predefined syntax and parameters relevant to the type of the protected resource 275. In some instances, different types of resources (e.g., a database such as MySQL database, servers, data storages, services, etc.) may follow different standards for storing configuration data including access policy metadata. A request to invoke access policy metadata for a given resource can be generated according to the respective standards for storing configuration data for the resource. In some instances, the generated request to obtain the access policy metadata 290 can include configuration parameters as defined for storing metadata for the protected resource 275 at a data storage that is of a particular type.

In some instances, the access policy interface 273 can use credentials 280 as stored at the protected resource 275 to determine whether the request for the access policy metadata is to be authorized. The determination of authorization can be performed by comparing provided credentials for an account associated with the request for the access policy metadata 290 by the automation tool 270 and corresponding credentials for the particular account as stored at the credentials 280.

In some instances, when the automation tool 270 performs a validation of request, for example, as described in relation to operations 235, 240, 245, and 250 of FIG. 2A, the automation tool 270 can obtain information for the access policy through the access policy interface 273, and can use that information to determine whether to validate the request to reduce the risk of locking the account used for accessing the protected resource 275. In some instances, the automation tool 270 can use the access policy metadata 290, as obtained by the access policy interface 273, to determine, for example, a log-on policy threshold value for allowed unsuccessful tries before locking the access to a resource in order to reduce the risk of locking an account, as discussed in relation to FIG. 2A, 3A, 3B.

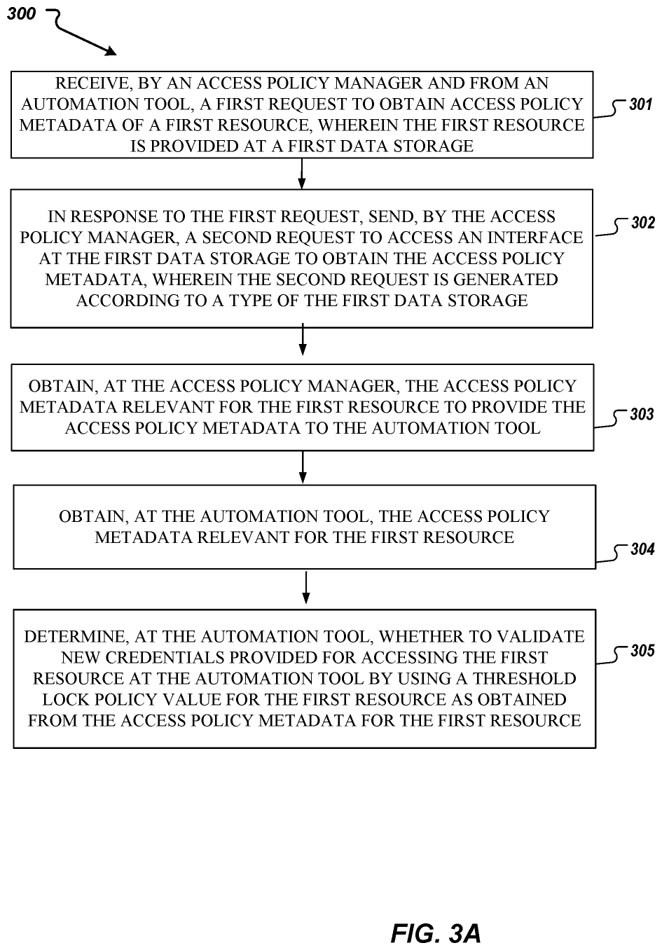

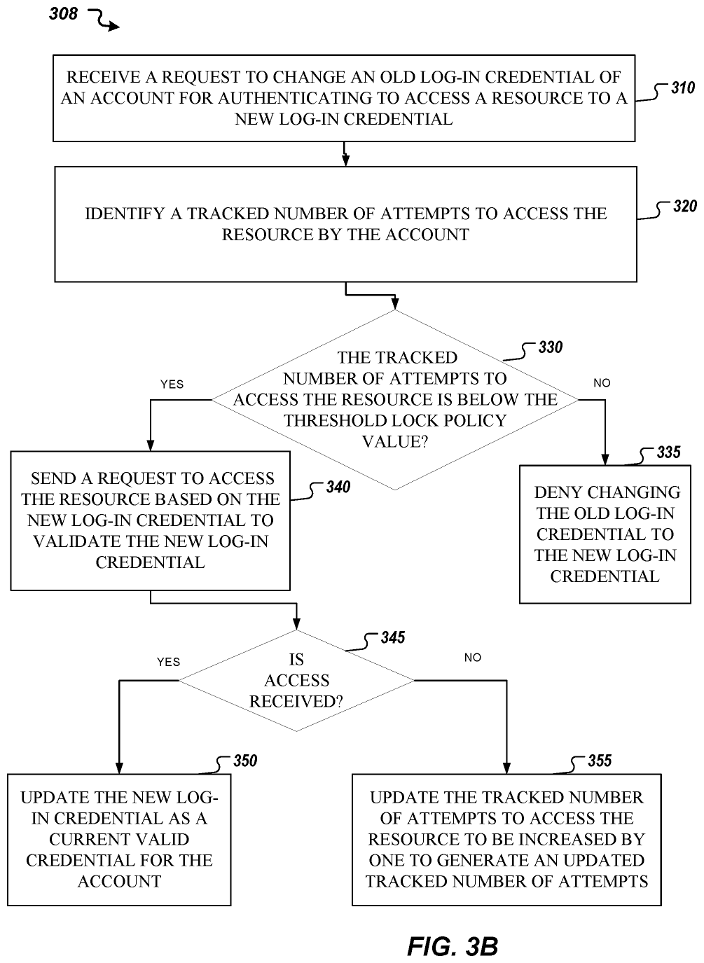

FIG. 3A is a flowchart for an example of a method 300 for obtaining access policy metadata for a protected resource in accordance with implementations of the present disclosure. In some instances, the method 300 can be executed at an access policy manager. The access policy manager can be, for example, a component that can implement an interface, such as the access policy interface 273 of FIG. 2B. In some instances, the access policy manager can be implemented to run as part of an automation tool, such as the automation tool 210 of FIG. 2A, or as automation tool 270 of FIG. 2B. In other instances, the access policy manager can run as a standalone entity that is in communication with an automation tool and a resource or resource provider.

At 301, a first request to obtain access policy metadata of a first resource is received at an access policy manager. The first request can be received from an automation tool, from an application, or from another entity, where the first request is to obtain the access policy metadata and use it when validating requests for performing operations related to the first resource. In some instances, the access policy metadata may be such that querying for such data may be specific to the type of the resource, and different from a manner of obtaining similar access policy metadata for another resource. Therefore, the first request can be processed according to the specifics of the first resource and configurations at the first resource to obtain the access policy metadata. In some instances, the first resource can be provided at a first data storage, which can include, for example, a database, a storage, or a server, among other examples.

In some instances, the automation tool can be configured to execute resource management operations over resources including the first resource. In some instances, the executed resource management operations can be pre-evaluated, for example, at the automation tool, based on processing obtained access policy metadata from the access policy manager. The obtained access policy metadata can include metadata for multiple resources, where the metadata can be obtained through invoking the data using different requests tailored to the specific type of the resource and storage of metadata for the resource. For example, an access policy manager can be configured to facilitate obtaining access policy metadata from various different resources as shown and described in relation to FIG. 4. In some instances, the obtained access policy metadata includes a threshold lock policy value for the first resource.

At 302, in response to the request, the access policy manager sends a second request to access an interface at the first data storage to obtain the access policy metadata. The second request can be generated according to the type of the first data storage. In some instances, when the second request is sent, the access policy manager can identify the type of the first data storage and generate the second request according to a metadata schema associated with the type of the first data storage to obtain the access policy metadata.

In some instances, the access policy manager can be configured to include one or more validator components, e.g., as described in relation to FIG. 4. The one or more validator components can be instantiated so that each validator component is associated with a type of a data storage (from a set of data storages to be used in connection with the access policy manager). In some instances, a validator component can be configured to generate requests according to a respective metadata schema associated with the respective type of the data storage. In some instances, a validator component corresponding to an identified type of the first data storage can be identified and the second request can be generated at that validator component. In some instances, the second request sent can be authenticated at the first data storage when received from the access policy manager. The authentication can be performed based on credentials provided by the access policy manager. The provided credentials can be obtained by the access policy manager through the first request received from the automation tool. The credentials can be validated to determine whether the second request is associated with an entity authorized to access resources at the first data storage.

At 303, the access policy metadata relevant for the first resource is obtained and provided to the automation tool.

At 304, the access policy metadata relevant for the first resource as obtained at the automation tool can be processed to determine a threshold lock policy value for the resource by extracting a respective threshold lock policy value from the access policy metadata.

At 305, the automation tool can determine whether to validate new credentials provided by an application for accessing the first resource through the automation tool. The validation of the new credentials can be performed by using the threshold lock policy value for the first resource as obtained from the access policy metadata for the first resource.

In some implementations, the access policy metadata can be used by the automation tool to process requests to perform operations for the first resource. For example, when the automation tool is configured to send the first request to the access policy manager responsive to a received request from an entity (e.g., application 265 of FIG. 2A) requesting to change account credentials to be used when authenticating the entity for accessing the first resource at the first data storage. In this example, the processing of the request can be performed as described by method 308 of FIG. 3B, where the automation tool, based on obtained access policy metadata, can process a request to change an old log-in credential of an account for authentication to access a resource to a new log-in credential.

FIG. 3B is a flowchart for an example method 308 for processing requests for updating credentials for accessing a resource in accordance with implementations of the present disclosure. In some instances, method 308 can be executed at an automation tool such as the previously discussed automation tool 210 and 270 in relation to FIGS. 2A and 2B respectively.

At 310, a request to change an old log-in credential of an account for authenticating to access a resource to a new log-in credential is received. The request is received from an entity authenticated at the automation tool, for example, a user or an application that is authenticated at the automation tool and has access to request the execution of the change of credentials. In some instances, the automation tool is configured to execute resource management operations over resources (including the resource that is to be accessed with the new log-in credentials). In some instances, the resources can be provided at a data center.

At 320, a tracked number of attempts to access the resource by the account is identified. The identification is done to determine whether to validate the new log-in credentials by determining whether the tracked number of attempts to access the resource by the account has reached a threshold lock policy value for the resource. In some instances, the tracked number of attempts can be determined based on a counter established at the automation tool and can be based on input from the resource to be notified that the request to access is not authenticated (e.g., as described in relation to operation 245 of FIG. 2A).

At 330, a determination is made as to whether the tracked number of attempts to access the resource has reached a threshold lock policy value (e.g., is below the threshold lock policy value). In some instances, the threshold lock policy value is a value associated with the log-on policy of the resource. In some instances, information about the log-on policy can be obtained directly from the resource or through external entities such as through an access policy manager as described in relation to FIGS. 2B, 3A, and 4. For example, the resource log-on policy can be obtained from (i) an external entity so that the automation tool can store access policy metadata and configure a log-on policy for the resource at the automation tool, (ii) an external entity that polls the information about the log-on policy from the resource and provides it to the automation tool, or (iii) the application that is associated with the automated actions configured for execution at the automation tool for resources including the resource, as well as other suitable sources.

If it is determined that the tracked number of attempts is not below the threshold value, then the new log-in credential is invalidated at the tool by determining that the tracked number of attempts to access the resource exceeds the threshold lock policy value. Based on this, method 308 continues at 335, where the changing of the old log-in credential to the new log-in credential is denied.

If it is determined that the tracked number of attempts is below the threshold value, then method 308 continues at 340, where a request to access the resource is sent based on the new log-on credentials. If access to the resource is received at 345, then, at 350 the new log-in credentials are updated as a current valid credential for the account. If access is denied at 345, then the tracked number of attempts to access the resource is increased by one to generate an updated tracked number of attempts at 355. Even though in this case the access is denied, the account is not locked as the allowed number of unsuccessful attempts to access the resource has not been exceeded (as determined at 330).

With method 308, the risk of executing a request to access a resource based on an unverified credential (verified at the resource by actually executing a successful attempt to access the resource) that could lead to locking the access to the resource is reduced. With the current method, a final attempt which is allowed to be performed before the account is locked is not executed with a new log-in credential that is newly provided for replacing the old credential. In some instances, if the tracked number of attempts is equal to the threshold lock policy value at 330, then, the method can deny changing the log-in credential 335 and/or wait for a threshold period of time (e.g., as provided in the log-on policy) before attempting to access the resource (as at 340). The subsequent attempt to access the resource can be performed after checking the tracked number of attempts, which can be reevaluated iteratively based on new requests received and/or the information about the log-on policy and any possible resetting of the tracking after a particular event (e.g., threshold period of time has lapsed, hard reset of the tracked number, a request with the credential from another source with proof of validity of the new credential, or else as configured at the tool).

FIG. 4 is a block diagram for an example of a system environment 400 for dynamic retrieval of access policies of various resources provided by multiple data storages in accordance with implementations of the present disclosure. In some instances, the system environment 400 includes an application 410 that can be an agent, resource consumer, service, or other entity. The system environment 400 can be similar to the system environment 255 of FIG. 2B, however the system environment 400 is configured to support an automation tool, such as a lifecycle tool 415, to obtain access policy metadata from various resources that store their access policy metadata according to different standards and technology.

In some instances, the lifecycle tool 415 can be configured to execute preconfigured flows related to managing resources accessible by the application 410. In some instances, the lifecycle tool 415 can be substantially similar to the automation tool 210 of FIG. 2A and can be configured to perform actions as described in relation to FIG. 2A.

In some instances, the access policy manager 420 can be configured to receive requests for access policy data from the lifecycle tool 415, where those requests may be associated with resources of different types that may be stored and managed according to different technologies and standards. The resource providers may have different configuration data and can define different properties to be able to invoke metadata for access policies. The invocation of the metadata for the access policy can be specific to the relevant resource provider and the type of configuration parameters. Below presented Tables 1, 2, 3, 4, and 5 include examples of security-related configuration parameters defined for different types of resource providers that are specific. Therefore, when a request is generated to obtain configuration information from a resource, the request can be generated according to the specifics and parameters of the different types of resource providers to invoke the access policy metadata. In some instances, the request to obtain the access policy metadata can be generated according to a syntax and configuration parameters relevant to the type of the resource provider.

TABLE 1
Linux Password Policy:
Configuration file /etc/pam.d/common-password
password [success=1 default=ignore] pam_unix.so obscure sha512 minlen=20
Linux User/Password Storage in files:
root@oscp:/# cat /etc/passwd
root:x:0:0:root:/root:/bin/bash
daemon:x:1:1:daemon:/usr/sbin:/usr/sbin/nologin
bin:x:2:2:bin:/bin:/usr/sbin/nologin
root@oscp:/# cat /etc/shadow
root:$y$j9T$lZKL3dlYQauJuIK0k7C0M/$FWXYbduJZeW/8glg9XwhT/Ozo3NN2mt6mgKuj
VcPtOB:19160:0:99999:7:::
daemon:*:19103:0:99999:7:::
bin:*:19103:0:99999:7:::

```
TABLE 2
Tomcat Web Server:
A config file is located in <TOMCAT_HOME>/conf named tomcat-users.xml.
<?xml version=‘1.0’ encoding=‘utf-8’?>
<tomcat-users>
  <role rolename=“admin”/>
  <user username=“admin” password=“superSecretCleartextPasswordInAFile”
roles=“standard,manager,admin”/>
</tomcat-users>
```

TABLE 3
Postgres database:
postgres=# SELECT * FROM pg_user;
usename | usesysid | usecreatedb | usesuper | userepl | usebypassrls | passwd | valuntil |
useconfig
----------+----------+-------------+----------+---------+--------------+----------+----------+-----------
postgres | 10 | t | t | t | t | ******** | |
(1 row)

TABLE 4

MySQL database Password Policy:
mysql> SHOW VARIABLES LIKE ‘validate_password.%’;
+-------------------------------------------------+--------+
| Variable_name | Value |
+-------------------------------------------------+--------+
| validate_password.changed_characters_percentage | 0 |
| validate_password.check_user_name | ON |
| validate_password.dictionary_file | |
| validate_password.length | 8 |
| validate_password.mixed_case_count | 1 |
| validate_password.number_count | 1 |
| validate_password.policy | MEDIUM |
| validate_password.special_char_count | 1 |
+-------------------------------------------------+--------+

TABLE 5

LDAP User directory:
Managing Password Policy via LDIF:
dn: cn=TempPolicy,dc=example,dc=com
objectClass: top
objectClass: pwdPolicy
objectClass: LDAPsubentry
cn: TempPolicy
pwdCheckQuality: 2
pwdLockout: TRUE
pwdLockoutDuration: 300
pwdMaxFailure: 3
pwdMustChange: TRUE
Managing User/Password via LDIF:
ldapmodify -h hostname -p port -D dn -w password <<!
dn: uid=user,dc=example,dc=com
changetype: modify
replace: userPassword
userPassword: new-password

In some instances, requests to invoke the access policy metadata from a resource can be handled by identifying an access policy schema creator from multiple access policy schema creators provided at the access policy manager 420. In some instances, based on a received request from a lifecycle tool 415 to obtain access policy metadata for a protected resource A 401, the access policy manager 420 can identify that the access policy schema creator A 425 is the creator that is instantiated to handle the type of the protected resource A 401. The access policy schema creator A 425 can generate a request to obtain access policy metadata from the protected resource A 401, by invoking the access policy interface A 430 according to request standards relevant for the access policy interface A 430. In some instances, the access policy schema creator A 425 can obtain access policy metadata for the protected resource A 401 by invoking the access policy interface A 430 according to a predefined syntax and parameters relevant to the type of the protected resource A 401. In some instances, different types of resources (e.g., database such as MySQL database, servers, data storages, services, etc.) may follow different standards for storing configuration data including access policy metadata. A request to invoke access policy metadata for a given resource can be generated according to the respective standards for storing configuration data for the resource. In some instances, the generated request to obtain the access policy metadata can include configuration parameters as defined for storing metadata for the resource at the particular type of resource.

In some instances, different access policy schema creators can be configured to process and request metadata from different types of resources (or data storages or resource providers), where the access policy schema creators generate the requests to be sent to an interface exposed by the resource. The resources, such as protected resource A 401 and protected resource B 402 that are communicatively coupled to the access policy manager 420 can be of different types, and can provide a specific access policy interface (e.g., access policy interface A and access policy interface B), where requests directed to the specific access policy interfaces can be different and include different parameters as expected by the respective interfaces.

In some instances, the lifecycle tool 415 may be configured to access the protected resource A 401 or B 402 for executing operations related to the application 410, for example, as described in relation to FIG. 3B. In some implementations, the lifecycle tool 415 can include logic to validate requests to perform operations requiring authentication in a manner that reduces the risk of locking an account in case of fraudulent requests using faulty credentials. The validation of requests at the lifecycle tool 415 can use the access policy data obtained through the access policy manager 420 and determine whether to accept, deny, or in some cases delay the execution of an operator to efficiently manage request processing and reduce risk of delays due to locking of accounts as discussed throughout the present disclosure.

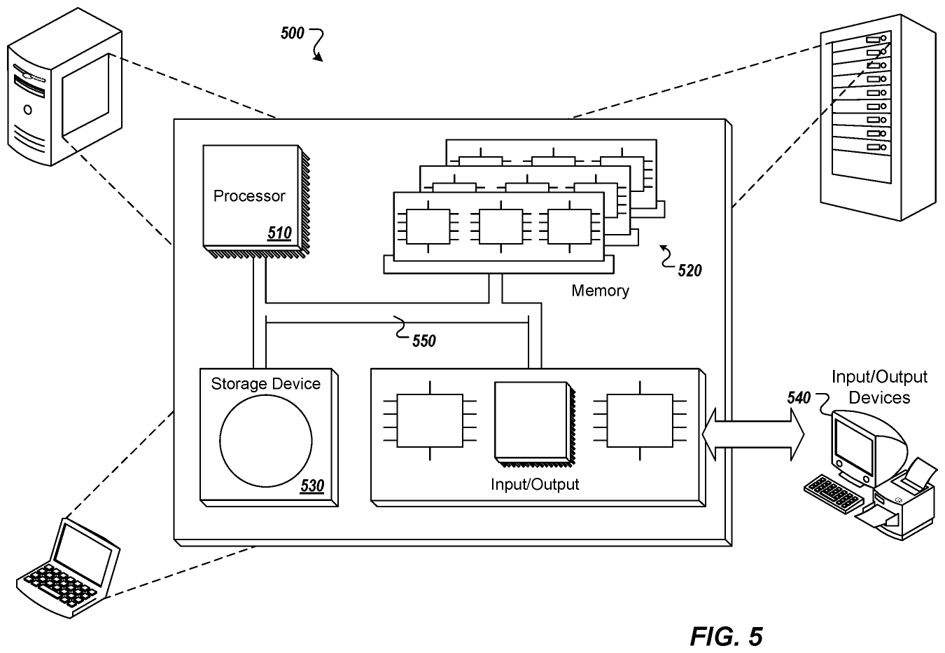

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, application-specific integrated circuits (ASICs).

To provide for interaction with a user, the features can be implemented on a computer having a display device, such as a cathode ray tube (CRT) or liquid crystal display (LCD) monitor for displaying information to the user and a keyboard and a pointing device, such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication, such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

In view of the above described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising:
receiving, at an access policy manager and from an automation tool, a first request to obtain access policy metadata of a first resource, wherein the first resource is provided at a first data storage;
in response to the request, sending, at the access policy manager, a second request to access an interface at the first data storage to obtain the access policy metadata, wherein the second request is generated according to a type of the first data storage; and
obtaining the access policy metadata relevant for the first resource to provide the access policy metadata to the automation tool.

Example 2. The method of Example 1, wherein sending the second request comprises:
identifying the type of the first data storage; and
generating the second request according to a metadata schema associated with the type of the first data storage to obtain the access policy metadata.

Example 3. The method of any one of the preceding Examples, comprising:
instantiating one or more validator components, each validator component being associated with a type of a data storage and being configured to generate requests according to a respective metadata schema associated with the respective type of the data storage;
wherein sending the second request comprising:
   identifying a validator component corresponding to an identified type of the first data storage, and wherein the second request is generated at the validator component.

Example 4. The method of any one of the preceding Examples, wherein the automation tool is configured to execute resource management operations over resources comprising the first resource, wherein the executed resource management operations are pre-evaluated based on processing obtained access policy metadata from the access policy manager, and wherein the obtained access policy metadata includes a threshold lock policy value for the first resource.

Example 5. The method of any one of the preceding Examples, comprising:
obtaining, at the automation tool, the access policy metadata relevant for the first resource; and
determining, at the automation tool, whether to validate new credentials provided for accessing the first resource at the automation tool by using a threshold lock policy value for the first resource as obtained from the access policy metadata for the first resource,
wherein the automation tool is configured to send the first request to the access policy manager responsive to a received request from an entity to change account credentials to be used when authenticating the entity for accessing the first resource at the first data storage.

Example 6. The method of any one of the preceding Examples, wherein the second request sent by the access policy manager to the first data storage is authenticated at the first data storage based on provided credentials by the access policy manager, wherein the provided credentials are obtained through the first request received from the automation tool, and wherein the credentials are validated to determine whether the second request is associated with an entity authorized to access resources at the first data storage.

Example 7. The method of any one of the preceding Examples, wherein the access policy manager is communicatively coupled to a plurality of data storages, at least two data storages being of different type and associated with a different metadata schema.

Example 8. The method of any one of the preceding Examples, comprising:
obtaining, at the automation tool and based on provided access policy metadata for resource from the access policy manager, one or more threshold lock policy value for one or more respective resource by extracting a respective threshold lock policy value from a respective access policy metadata;
receiving, at the automation tool, a third request to change an old log-in credential of an account for authenticating to access a resource to a new log-in credential, wherein the third request is received from an entity authenticated at the automation tool, and wherein the automation tool is configured to execute resource management operations over resources comprising the resource;
determining, at the automation tool, whether to validate the new log-in credential by determining whether a tracked number of attempts to access the resource by the account has reached a threshold lock policy value for the resource, wherein the threshold lock policy value is identified as relevant for the resource that is associated with the third request to change the old log-in credential to a new log-in credential for the account; and
in response to invalidating the new log-in credential by determining that the tracked number of attempts to access the resource exceeds the threshold lock policy value, denying, by the automation tool, changing the old log-in credential to the new log-in credential.

Example 9. The method of Example 8, wherein the entity is a user associated with the account, wherein the account is associated with one or more data storages and with the user, and wherein the account is usable for accessing resources at the one or more data storages.

Example 10. The method of any one of Examples 8 and 9, wherein the entity is an application associated with the account, and wherein the account is usable for authenticating to access resources at a data storage based on a current version of stored log-in credential, wherein the data storage is a database.

Example 11. The method of any one of Examples 8 to 10, comprising:
in response to determining that the tracked number of attempts to access the resource is below the threshold lock policy value,
   sending a request to access the resource based on the new log-in credential to validate the new log-in credential, and
   in response to receiving access to the resource based on the new log-in credential, updating the new log-in credential as a current valid credential for the account for accessing resources at a storage comprising the resource.

Example 12. The method of any one of Examples 8 to 11, wherein the account is configured at the automation tool, and wherein the method comprises:
storing information for a log-on policy for accessing resources at the data center, wherein the storing comprises:
   obtaining the threshold lock policy value associated with the resource.

Example 13. The method of any one of Examples 8 to 12, wherein the method comprises:
tracking, at the automated tool, the number of attempts to access the resource based on provided credentials from entities authenticated at the automated tool.

Example 14. The method of any one of Examples 8 to 13, comprising:
retrieving a log-on policy associated with the resource, the log-on policy comprising the threshold lock policy value.

Example 15. The method of any one of Examples 8 to 14, comprising:
in response to determining that the tracked number of attempts to access the resource is below the threshold lock policy value,
sending a request to access the resource based on the new log-in credential to validate the new log-in credential, and
in response to receiving a notification for denied access to the resource based on the new log-in credential, updating the tracked number of attempts to access the resource by increasing with one to generate an updated tracked number of attempts to be used for subsequent determinations to validate requests for changes of credentials of the account.

What is claimed is:

1. A computer-implemented method, the method comprising:
receiving, by an access policy manager and from an automation tool, a first request to obtain access policy metadata of a first resource, wherein the first resource is provided at a first data storage;
in response to the first request, sending, by the access policy manager, a second request to access an interface at the first data storage to obtain the access policy metadata, wherein the second request is generated according to a type of the first data storage; and
obtaining the access policy metadata relevant for the first resource to provide the access policy metadata to the automation tool.

2. The method of claim 1, wherein sending the second request comprises:
identifying the type of the first data storage; and
generating the second request according to a metadata schema associated with the type of the first data storage to obtain the access policy metadata.

3. The method of claim 1, comprising:
instantiating one or more validator components, each validator component being associated with a type of a data storage and being configured to generate requests according to a respective metadata schema associated with the respective type of the data storage;
wherein sending the second request comprises:
identifying a validator component corresponding to an identified type of the first data storage, and wherein the second request is generated at the validator component.

4. The method of claim 1, wherein the automation tool is configured to execute resource management operations over resources comprising the first resource, wherein the executed resource management operations are pre-evaluated based on processing obtained access policy metadata from the access policy manager, and wherein the obtained access policy metadata includes a threshold lock policy value for the first resource.

5. The method of claim 1, comprising:
obtaining, by the automation tool, the access policy metadata relevant for the first resource; and
determining, by the automation tool, whether to validate new credentials provided for accessing the first resource at the automation tool by using a threshold lock policy value for the first resource as obtained from the access policy metadata for the first resource,
wherein the automation tool is configured to send the first request to the access policy manager responsive to a received request from an entity to change account credentials to be used when authenticating the entity for accessing the first resource at the first data storage.

6. The method of claim 1, wherein the second request sent by the access policy manager to the first data storage is authenticated at the first data storage based on credentials provided by the access policy manager, wherein the credentials are obtained through the first request received from the automation tool, and wherein the credentials are validated to determine whether the second request is associated with an entity authorized to access resources at the first data storage.

7. The method of claim 1, wherein the access policy manager is communicatively coupled to a plurality of data storages, at least two data storages being of different type and associated with a different metadata schema.

8. The method of claim 1, comprising:
obtaining, at the automation tool and based on provided access policy metadata for resource from the access policy manager, one or more threshold lock policy value for one or more respective resource by extracting a respective threshold lock policy value from a respective access policy metadata;
receiving, at the automation tool, a third request to change an old log-in credential of an account for authenticating to access a resource to a new log-in credential, wherein the third request is received from an entity authenticated at the automation tool, and wherein the automation tool is configured to execute resource management operations over resources comprising the resource;
determining, at the automation tool, whether to validate the new log-in credential by determining whether a tracked number of attempts to access the resource by the account has reached a threshold lock policy value for the resource, wherein the threshold lock policy value is identified as relevant for the resource that is associated with the third request to change the old log-in credential to a new log-in credential for the account; and
in response to invalidating the new log-in credential by determining that the tracked number of attempts to access the resource exceeds the threshold lock policy value, denying, by the automation tool, changing the old log-in credential to the new log-in credential.

9. A non-transitory computer-readable medium coupled to one or more processors and having instructions stored thereon which, when executed by the one or more processors, cause the one or more processors to perform operations, the operations comprising:
receiving, by an access policy manager and from an automation tool, a first request to obtain access policy metadata of a first resource, wherein the first resource is provided at a first data storage;
in response to the first request, sending, by the access policy manager, a second request to access an interface at the first data storage to obtain the access policy metadata, wherein the second request is generated according to a type of the first data storage; and
obtaining the access policy metadata relevant for the first resource to provide the access policy metadata to the automation tool.

10. The non-transitory computer-readable medium of claim 9, wherein sending the second request comprises:
identifying the type of the first data storage; and
generating the second request according to a metadata schema associated with the type of the first data storage to obtain the access policy metadata.

11. The non-transitory computer-readable medium of claim 9, the operations comprising:
instantiating one or more validator components, each validator component being associated with a type of a data storage and being configured to generate requests according to a respective metadata schema associated with the respective type of the data storage;
wherein sending the second request comprises:
identifying a validator component corresponding to an identified type of the first data storage, and wherein the second request is generated at the validator component.

12. The non-transitory computer-readable medium of claim 9, wherein the automation tool is configured to execute resource management operations over resources comprising the first resource, wherein the executed resource management operations are pre-evaluated based on processing obtained access policy metadata from the access policy manager, and wherein the obtained access policy metadata includes a threshold lock policy value for the first resource.

13. The non-transitory computer-readable medium of claim 9, the operations comprising:
obtaining, by the automation tool, the access policy metadata relevant for the first resource; and
determining, by the automation tool, whether to validate new credentials provided for accessing the first resource at the automation tool by using a threshold lock policy value for the first resource as obtained from the access policy metadata for the first resource,
wherein the automation tool is configured to send the first request to the access policy manager responsive to a received request from an entity to change account credentials to be used when authenticating the entity for accessing the first resource at the first data storage.

14. The non-transitory computer-readable medium of claim 9, wherein the second request sent by the access policy manager to the first data storage is authenticated at the first data storage based on credentials provided by the access policy manager, wherein the credentials are obtained through the first request received from the automation tool, and wherein the credentials are validated to determine whether the second request is associated with an entity authorized to access resources at the first data storage.

15. The non-transitory computer-readable medium of claim 9, wherein the access policy manager is communicatively coupled to a plurality of data storages, at least two data storages being of different type and associated with a different metadata schema.

16. A system comprising
a computing device; and
a computer-readable storage device coupled to the computing device and having instructions stored thereon which, when executed by the computing device, cause the computing device to perform operations, the operations comprising:
receiving, by an access policy manager and from an automation tool, a first request to obtain access policy metadata of a first resource, wherein the first resource is provided at a first data storage;
in response to the first request, sending, by the access policy manager, a second request to access an interface at the first data storage to obtain the access policy metadata, wherein the second request is generated according to a type of the first data storage; and
obtaining the access policy metadata relevant for the first resource to provide the access policy metadata to the automation tool.

17. The system of claim 16, wherein sending the second request comprises:
identifying the type of the first data storage; and
generating the second request according to a metadata schema associated with the type of the first data storage to obtain the access policy metadata.

18. The system of claim 16, the operations comprising:
instantiating one or more validator components, each validator component being associated with a type of a data storage and being configured to generate requests according to a respective metadata schema associated with the respective type of the data storage;
wherein sending the second request comprises:
identifying a validator component corresponding to an identified type of the first data storage, and wherein the second request is generated at the validator component.

19. The system of claim 16, wherein the automation tool is configured to execute resource management operations over resources comprising the first resource, wherein the executed resource management operations are pre-evaluated based on processing obtained access policy metadata from the access policy manager, and wherein the obtained access policy metadata includes a threshold lock policy value for the first resource.

20. The system of claim 16, the operations comprising:
obtaining, by the automation tool, the access policy metadata relevant for the first resource; and
determining, by the automation tool, whether to validate new credentials provided for accessing the first resource at the automation tool by using a threshold lock policy value for the first resource as obtained from the access policy metadata for the first resource,
wherein the automation tool is configured to send the first request to the access policy manager responsive to a received request from an entity to change account credentials to be used when authenticating the entity for accessing the first resource at the first data storage.
